(19) United States
(12) Patent Application Publication
(10) Pub. No.: US 2007/0254076 A1
(43) Pub. Date: Nov. 1, 2007

(54) Method for extracting and recovery of water from organic materials employing supercritical carbon dioxide utilizing a heat exchanger system

(76) Inventors: James Edward Bobier JR., Hutchinson, MN (US); Michael Wayne Davis, Rockford, MN (US)

Correspondence Address: MARK STEVEN LEWANDOWSKI, 1357 WESTWOOD ROAD, HUTCHINSON, MN, 55350, US

(21) Appl. No.: 11/726,111

(22) Filed: Mar. 20, 2007

Related U.S. Application Data
(60) Provisional application No. 60/786,748, filed on Mar. 27, 2006.

(51) Int. Cl. A23L 1/015

(52) U.S. Cl. 426/426; 426/476; 426/494

(57) ABSTRACT

The removal of excess water from organic materials, specifically distillers grains, employing the use of supercritical carbon dioxide. The method includes the use of a heat exchanger system which is aids in the recovery and separation of the water from the supercritical carbon dioxide in a recovery loop. A supercritical carbon dioxide process loop cycles through an extraction chamber where it solubilizes excess water from organic material. This high water content supercritical carbon dioxide then passes out of the extraction chamber and through a heat exchanger system to cool the materials. The ability for supercritical carbon dioxide to solubilize water is a dependant upon temperature. A reduction in temperature results in the water precipitating out of the supercritical carbon dioxide, (or liquid carbon dioxide,) at which time is easily separated and removed from the system. The carbon dioxide then proceeds through the return side loop, through the heat exchanger system to increase the temperature, and enters the extraction chamber to solubilize water once more.

### RELATED APPLICATIONS

This application claims priority to U.S. Provisional Application No. 60/786,748 filed Mar. 27, 2006 which is hereby incorporated by reference in its entirety.

### BACKGROUND OF INVENTION

1. Field of the Invention

The present invention relates to the use of a supercritical carbon dioxide system for the extraction, removal, and subsequent recovery of water from a moist or wet organic substance. More preferably, this relates to a process system in which both a supercritical carbon dioxide phase and a liquid carbon dioxide phase are employed. By also using a heat exchanger, this provides a highly energy efficient method to remove water for the drying of materials, such as distillers grains and other organic materials.

2. Description of Related Art

The term “supercritical carbon dioxide” herein refers to a state in which carbon dioxide is neither in a gaseous or liquid state. Rather, it is a physical state which exhibits characteristics of both the gaseous and liquid states. Furthermore, the term “supercritical carbon dioxide” herein refers to carbon dioxide which is at a pressure of 73 atmospheres (roughly 1073 psi) or greater, and at a temperature of 31.1° C. or higher. Any potential condition of carbon dioxide with values equal to or greater than these two aforementioned variables is considered to be “supercritical”. The term “organic material” herein refers to material which is composed of and/or derived from plant or animal life, (flora & fauna). The term “distillers grains” herin refers to the remaining grain based, organic solids and solubles resulting from a fermentation and distillation process. More specifically, “distillers grains” refer to any of the typical grains used in alcohol production, such as but not limited to corn, wheat, and rice. The term “Wet Distillers Grains” (WDG) herein refers to any form of distillers grains and distillers grains with solubles with a water content greater than 20%. This includes wet distillers grains (WDG) and wet distillers grains with solubles (WDGS) which are typically 70% moisture, modified distillers grains (MDG) and modified distillers grains with solubles (MDGS) which are typically 50% moisture. The term “Dried Distillers Grains” (DDG) herein refers to any form of distillers grains and distillers grains with solubles with a water content less than 20%. This includes dried distillers grains (DDG) and dried distillers grains with solubles (DDGS).

Presently, a great amount of distillers grains are produced in the production of ethanol. The majority of these processing plants consume corn as the primary grain, and the resulting distillers grains are then used as livestock feed. Both wet distillers grains and dried distillers grains are commonly used as livestock feed. Wet distillers grains have some major disadvantages compared to dried distillers grains: lower food value to weight ratio resulting in greater shipping costs, shortened shelf life due to the high water content, difficulty in handling and transporting product since the outer surfaces of a pile will tend to naturally dry and crust over. The major disadvantage of dried distillers grains is the required amount of energy and associated cost consumed in the drying process. Distillers grains used for livestock feed are commonly dried to a range of 8 to 15% percent water content by weight. In doing so, the distillers grains become a granular product which can easily be handled, the food value to weight ratio increases so shipping costs are reduced, and the product can be stored for much longer periods of time. Currently, the common method used by ethanol plants for drying, or removing excess water, from distillers grains is by heating the wet distillers grains in a rotary tumble dryer. This is typically a singular or plurality of long rotary drums in which the wet distillers grains enter the drum from one end and are conveyed through the dryer while tumbled. The tumbling action is required in this application to prevent the distillers grains from caking together. These rotary driers are typically heated with natural gas, propane, or coal. An analysis of the current method for drying distillers grains as a co-product in the production of ethanol shows that a highly efficient system requires approximately 3000 BTUs of heat energy to remove 1 pound of water from the distillers grains. A method that consumes less energy would be highly desirable.

Supercritical carbon dioxide is used in many activities. These include, but are not limited to the decaffeination of coffee beans, removing oils from materials, and processing of semiconductor wafers. A method for drying water from semiconductor wafers using supercritical carbon dioxide and a co-solvent is provided in U.S. Pat. No. 6,398,875. Furthermore, a 3 step method for drying microstructure members employing supercritical carbon dioxide in one of the steps is provided in U.S. Pat. No. 6,804,900. A NASA abstract titled “Recovery of Minerals in Martian Soil via Supercritical Fluid Extraction” by Keneth Debelak of Vanderbilt University discloses how water is recovered from hydrated species of Martian soil when exposed to supercritical carbon dioxide. In this paper, it is disclosed that the solubility of water in supercritical carbon dioxide was experimentally found to be 0.052 mole fraction, when the temperature was approximately 295° F. and the pressure was approximately 3500 psi.

Supercritical carbon dioxide extraction processes typically recover the extracts by means of reducing the pressure so that the supercritical carbon dioxide changes phase into the gaseous state. This provides a simple way to recover most extracts since the gaseous carbon dioxide can no longer solubilize the extract to the level that the supercritical carbon dioxide was able to. So the extract precipitates out of suspension in a liquid or solid form. The drawback to this process is that to recycle the gaseous carbon dioxide back into the supercritical state to be used for additional extraction requires increasing the pressure of the carbon dioxide, which is fairly energy intensive.

### SUMMARY OF THE INVENTION

Accordingly, the primary object of the present invention is to provide a highly energy efficient method for removing water from organic materials such as but not limited to distillers grains in which water is removed from the distillers grains employing supercritical carbon dioxide with or without the aid of a co-solvent in a highly energy efficient and cost effective manner. The optimal method for the present invention consists of the use of a water extraction chamber in which supercritical carbon dioxide, with or without the aid of a co-solvent, solubilizes and extracts water from organic materials and a recovery chamber in which liquid water and other precipitates are separated from high pressure liquid carbon dioxide which are coupled together via a circulation loop which passes through a heat exchanger to cool the supercritical carbon dioxide which is saturated with water upon exiting the extraction chamber and conversely heat the high pressure liquid carbon dioxide as it is pumped from the recovery chamber back toward the extraction chamber. The heat exchanger provides a highly energy efficient means to convert the supercritical carbon dioxide into liquid carbon dioxide for recovery of the water. The liquid carbon dioxide is then pumped back through the heat exchanger where the increase in temperature results in a phase transformation back into supercritical carbon dioxide. This supercritical carbon dioxide is now at a state of unsaturated water content and is ready to be returned to the extraction chamber to solubilize additional water. This process may also consist of multiple check valves to prevent the potential for backflow, one or more pumps to provide circulation of the carbon dioxide, and a heat source to provide any necessary make-up heat to offset heat losses. Throughout the process loop, the pressure is kept as close to constant as possible. High pressure, (equal or greater than roughly 1073 psi), and modest temperature, (equal or greater than roughly 88° F.), are required for carbon dioxide to be in the supercritical state. This high pressure is maintained throughout the supercritical carbon dioxide—liquid carbon dioxide circulation loop. There may be some slight pressure changes due to the use of check valves. However, the optimal goal is to keep the pressure change as small as possible to minimize the energy required for the circulation of the carbon dioxide throughout the system. Through the use of check valves, the system would be allowed to equalize pressure throughout the circulation loop, thus minimizing the compression requirement on the circulation pump. The carbon dioxide phase change, and subsequent recovery of the water is accomplished by means of a heat exchanger which minimizes the amount of energy which is required to enable a supercritical carbon dioxide—liquid carbon dioxide circulation loop. As the supercritical carbon dioxide exiting the extraction chamber is cooled to cause a phase change into the liquid state, the heat energy is recovered and applied to the liquid carbon dioxide to aid it in reverting back to the supercritical state as it is being pumped back to the extraction chamber with as little energy loss as possible.

In a slightly alternate version of the process described above, the carbon dioxide would be continuously kept in the supercritical state. In this version, the heat exchanger would provide a temperature change so that the supercritical carbon dioxide in the extraction chamber would be at a significantly different temperature than the supercritical carbon dioxide in the water recovery and separation chamber, and thus exhibit significantly different capabilities to solubilize water. For example, the extraction side could have a temperature of 295° F., for which water would solubilize to approximately 0.052 molar. When this high temperature, saturated supercritical carbon dioxide passes through the heat exchanger, it is cooled to approximately 100° F., at which point it is still in the supercritical state, but its ability to solubilize water has been reduced to approximately 0.0045 molar, so most of the water will precipitate out and be removed from the process loop.

The preferred method is a process in which the pressure of the supercritical carbon dioxide is between 1073 psi to 1500 psi, the temperature of the supercritical carbon dioxide in the extraction vessel is between 90° C. to 150° C., and the temperature of the carbon dioxide in the recovery chamber between 20° C. to 31.1° C. The solubility of water into supercritical carbon dioxide is fairly insensitive to pressure, so the lower pressure range is preferable from an equipment cost to benefit comparison. The solubility of water into supercritical carbon dioxide is sensitive to temperature, with the solubility increasing substantially near 100° C. and above. By using an extraction temperature of at least 90° C., the solubility ratio will be sufficient. By limiting the extraction temperature to 150° C. or below, heat damage to the organic material should be kept to acceptable levels. For organic materials in which there are no concerns of heat damage, the temperature could exceed 150° C. The recovery temperature range is set between 20° C. to 31.1° C. to ensure that the carbon dioxide is converted to the liquid state. By having the carbon dioxide converted to the liquid state, the separation of the water from the liquid carbon dioxide should be relatively easy due to the differences in specific gravity. Furthermore, by maintaining the temperature of the liquid carbon dioxide near to, but just below the supercritical state in the recovery chamber will minimize the temperature gradient needed for the heat exchanger system.

### BRIEF DESCRIPTION OF THE DRAWINGS

FIG. 1 of the drawings is a temperature versus pressure phase diagram for carbon dioxide which shows the gas, solid, liquid, and supercritical states along with a back and forth arrow indicating an approximate region or process window that carbon dioxide could be utilized for this invention.

FIG. 2 of the drawings is a schematic representation of a highly energy efficient supercritical carbon dioxide extraction system in which water is extracted and recovered utilizing a supercritical carbon dioxide phase—liquid carbon dioxide phase process.

### DETAILED DESCRIPTION OF THE DRAWINGS

The embodiments of the present invention described below are not intended to be exhaustive or to limit the invention to the particular embodiments disclosed in the following detailed description. Rather, the embodiments are described so that others skilled in the art can understand the principles and practices of the present invention.

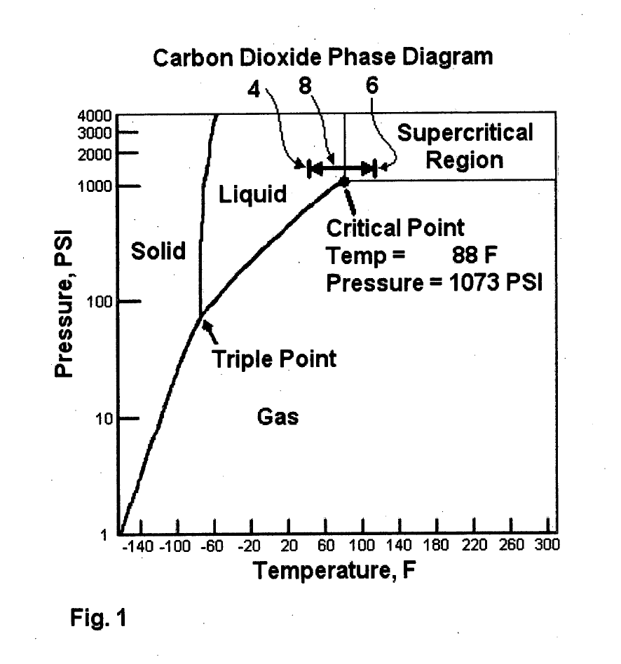

FIG. 1 of the drawings show a temperature versus pressure phase diagram for carbon dioxide. Shown in the phase diagram is a process window 8, represented by a back and forth arrow. Point 4 represents the state of the liquid carbon dioxide as it would be in the recovery chamber. Point 6 represents the state of the supercritical carbon dioxide as it would be in the extraction chamber. The difference between the liquid carbon dioxide state 4 and supercritical carbon dioxide state 6 is a difference in temperature. It is important to note that the process window 8 is shown as a constant pressure cycle, however slight pressure changes are likely to exist.

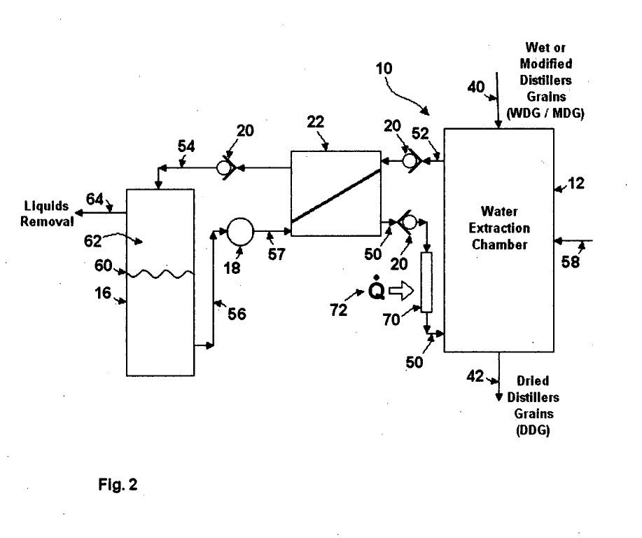

FIG. 2 of the drawings show a potential supercritical extraction process 10 for the removal of water from Wet Distillers Grains (WDG) or Modified Distillers Grains (MDG) 40. WDG or MDG 40 enters the water extraction chamber 12 while Dried Distillers Grains (DDG) exits the water extraction chamber 42. Supercritical carbon dioxide 50 is supplied to the water extraction chamber 12. The supercritical carbon dioxide solubilizes the water from the distillers grains in the water extraction chamber 12.

Supercritical carbon dioxide which is loaded with solubilized water 52 exits the water extraction chamber 12 and passes across a check valve 20 and enters the heat exchanger 22. As heat is removed from the supercritical carbon dioxide which is loaded with solubilized water, the carbon dioxide changes phase into liquid carbon dioxide upon the temperature reaching approximately 88° F. or less. The liquid carbon dioxide, water and other precipitates 54 exit the heat exchanger 22 and pass across an additional check valve 20. The liquid carbon dioxide, water and other precipitates 54 enter the liquid recovery chamber 16. Since the specific gravity of liquid carbon dioxide is greater than water, the water easily separates out and collects at the top of the tank as liquid water 62. The separation level 60 represents the natural occurring boundary between the liquid carbon dioxide and lighter liquid water 62. Liquid water 62 is removed from the chamber by means of an exit port 64 as needed. Liquid carbon dioxide 56 exits the liquid recovery chamber 16 and proceeds to the circulation pump 18, which also provides any slight pressure increase that might be required due to pressure drops across the check valves 20. Upon exit from the circulation pump 18 the liquid carbon dioxide 57 enters the heat exchanger 22 and transforms into supercritical carbon dioxide upon reaching approximately 88° F. The supercritical carbon dioxide which is in a water unsaturated state 50 exits the heat exchanger 22, passes through a check valve 20 and enters a make-up heat source 70. The make-up heat source 70 supplies additional heat 72 to the system to offset losses which occur in the heat exchanger and elsewhere in the system. The supercritical carbon dioxide which is in a water unsaturated state 50 exits the make-up heat source 70 and enters the water extraction chamber 12 to repeat the cycle. Make-up supercritical carbon dioxide is supplied to the water extraction chamber 12 by means of a supercritical make-up supply 58 to offset the losses of carbon dioxide that occur as the distillers grains enter 40 and exit 42 the water extraction chamber 12 by means such as load locks. The make-up supply 58 is also the means by which the system is initially pressurized. This completes the entire process loop which runs continuously. In the description of FIG. 2, only water was extracted from the distillers grains. Other materials may also be extracted concurrently which were not described specifically, furthermore, distillers grains are not the only application but rather one example of how a system would potentially operate.

It is recognized that changes, variations, and modifications may be made to this invention, particularly by those skilled in the art, without departing from the spirit and scope of this invention. Accordingly, no limitation is intended to be imposed on this invention, except as set forth in the accompanying claims.

We claim:

1. A method for removing excess water from organic materials consisting of:
a. The use of supercritical carbon dioxide for solubilizing and extracting the water from the organic materials;
b. The conversion of supercritical carbon dioxide which contains solubilized water into liquid carbon dioxide by means of a temperature change through the use of a heat exchanger system to enable separation and recovery of the water from the liquid carbon dioxide.

2. The method as recited in claim 1 in which the organic material is distillers grains.

3. The method as recited in claim 2 in which a co-solvent is used to aid in the removal of excess water.

4. The method as recited in claim 3 in which the co-solvent is ethanol.

5. The method as recited in claim 1 in which the organic material is biomass residuals from ethanol and/or cellulosic ethanol conversion processes.

6. The method as recited in claim 1 in which a co-solvent is used to aid in the removal of excess water.

7. The method as recited in claim 6 in which the co-solvent is ethanol.

8. The method as recited in claim 1 in which the pressure difference between the supercritical carbon dioxide pressure and liquid carbon dioxide pressure are kept within 10%.

9. The method as recited in claim 8 in which the organic material is distillers grains.

10. The method as recited in claim 9 in which a co-solvent is used to aid in the removal of excess water.

11. The method as recited in claim 10 in which the co-solvent is ethanol.

12. The method as recited in claim 8 in which a co-solvent is used to aid in the removal of excess water.

13. The method as recited in claim 12 in which the co-solvent is ethanol.

14. The method as recited in claim 1 in which the pressure difference between the super supercritical carbon dioxide pressure and liquid carbon dioxide pressure are kept within 3%.

15. The method as recited in claim 14 in which the organic material is distillers grains.

16. The method as recited in claim 15 in which a co-solvent is used to aid in the removal of excess water.

17. The method as recited in claim 16 in which the co-solvent is ethanol.

18. The method as recited in claim 14 in which a co-solvent is used to aid in the removal of excess water.

19. The method as recited in claim 18 in which the co-solvent is ethanol.

20. A method for removing excess water from organic materials consisting of:
a. The use of supercritical carbon dioxide for solubilizing and extracting the water from the organic materials;
b. The lowering of the supercritical carbon dioxide's ability to solubilize water by reducing the temperature by means of a heat exchanger system to allow separation and recovery of water from the supercritical carbon dioxide.

21. The method as recited in claim 20 in which the organic material is distillers grains.

22. The method as recited in claim 21 in which a co-solvent is used to aid in the removal of excess water.

23. The method as recited in claim 22 in which the co-solvent is ethanol.

24. The method as recited in claim 20 in which the organic material is biomass residuals from ethanol and/or cellulosic ethanol conversion processes.

25. The method as recited in claim 20 in which a co-solvent is used to aid in the removal of excess water.

26. The method as recited in claim 25 in which the co-solvent is ethanol.

27. The method as recited in claim 20 in which the pressure difference between the supercritical carbon dioxide pressure and liquid carbon dioxide pressure are kept within 10%.

28. The method as recited in claim 27 in which the organic material is distillers grains.

29. The method as recited in claim 28 in which a co-solvent is used to aid in the removal of excess water.

30. The method as recited in claim 29 in which the co-solvent is ethanol.

31. The method as recited in claim 27 in which a co-solvent is used to aid in the removal of excess water.

32. The method as recited in claim 31 in which the co-solvent is ethanol.

33. The method as recited in claim 20 in which the pressure difference between the super supercritical carbon dioxide pressure and liquid carbon dioxide pressure are kept within 3%.

34. The method as recited in claim 33 in which the organic material is distillers grains.

35. The method as recited in claim 34 in which a co-solvent is used to aid in the removal of excess water.

36. The method as recited in claim 35 in which the co-solvent is ethanol.

37. The method as recited in claim 33 in which a co-solvent is used to aid in the removal of excess water.

38. The method as recited in claim 37 in which the co-solvent is ethanol.
